(19) United States
(12) Patent Application Publication
(10) Pub. No.: US 2013/0058696 A1
(43) Pub. Date: Mar. 7, 2013

(54) DOCUMENT CREATING DEVICE, TAPE PRINTING APPARATUS, AND DOCUMENT CREATING METHOD

(71) Applicant: Noriaki Murayama, Matsumoto-shi (JP)

(72) Inventor: Noriaki Murayama, Matsumoto-shi (JP)

(73) Assignee: Seiko Epson Corporation, Tokyo (JP)

(21) Appl. No.: 13/595,464

(22) Filed: Aug. 27, 2012

(30) Foreign Application Priority Data
Sep. 7, 2011 (JP) 2011-195344

(51) Int. Cl. B41J 19/00

(52) U.S. Cl. 400/325

(57) ABSTRACT

A document creating device capable of creating plural paragraphs, each including one or more lines, the paragraphs being arrayed in a left-right direction that is a direction of line, the device comprising: a new paragraph creating unit for creating a new paragraph when a right cursor key for shifting a character spacing to the right is pressed in the state where a cursor is placed on a final character in a final line of the paragraph.

CROSS-REFERENCE

The entire disclosure of Japanese Patent Application No. 2011-195344 filed on Sep. 7, 2011, which is hereby incorporated by reference in its entirety.

### BACKGROUND

According to the related art, a tape printing apparatus which can create plural paragraphs, each including one or more lines, the paragraphs being arrayed in a left-right direction that is a direction of line, is known. For example, User's Manual of “TEPRA” PRO SR550, First Edition, July 2009, KING JIM CO., LTD., pp. 45-46 (Increase paragraphs (paragraph break)) describes that coexistence of various numbers of lines and change of design for each paragraph can be realized by providing plural paragraphs on one label. That is, by arranging plural paragraphs with various numbers of lines and designs arrayed in a direction of tape length, various different labels can be created.

Meanwhile, in the device described in User's Manual of “TEPRA” PRO SR550, First Edition, July 2009, KING JIM CO., LTD., pp. 45-46 (Increase paragraphs (paragraph break)), to create a new paragraph, a cursor is put on the final character of an existing paragraph and then a [Shift] key and a [Return] key are simultaneously pressed. At this point, on the editing screen, a beginning-of-line mark of a new paragraph is provided below a character string display area of the existing paragraph and the cursor is put on the beginning-of-line mark. That is, when a paragraph break operation is carried out, as in the case where a line break operation within a paragraph is carried out, characters of the new paragraph are to be inputted in the line that follows the line where the cursor is placed before the paragraph break operation.

However, with the configuration where a new paragraph is created by the [Shift] key+the [Return] key, as described above, there is a problem that the operation is not easy to understand to a user who carries out paragraph creation for the first time. This is because paragraph break creates a new paragraph on the right-hand side of the existing paragraph and therefore the user intuitively feels as if the editing position shifts to the right but such user's feeling does not match the operation of the [Shift] key +the [Return] key. Therefore, when wishing to create a new paragraph, the user needs to check the operation method with reference to the user's manual.

### SUMMARY

An advantage of some aspect of the invention is that a document creating device, a tape printing apparatus and a document creating method that enable creation of a new paragraph by an intuitive operation are provided.

An aspect of the invention is directed to a document creating device capable of creating plural paragraphs, each including one or more lines, the paragraphs being arrayed in a left-right direction that is a direction of line. The device includes a new paragraph creating unit which creates a new paragraph when a right cursor key for shifting a character spacing to the right is pressed in the state where a cursor is placed on a final character in a final line of the paragraph.

Another aspect of the invention is directed to a document creating method capable of creating plural paragraphs, each including one or more lines, the paragraphs being arrayed in a left-right direction that is a direction of line. The method includes creating a new paragraph when a right cursor key for shifting a character spacing to the right is pressed in the state where a cursor is placed on a final character in a final line of the paragraph.

With these configurations, a new paragraph is created by pressing the right cursor key. Therefore, the paragraph break operation and the position where the new paragraph is created are linked with each other. Thus, even a beginner can create a new paragraph by an intuitive operation without referring to a user's manual.

In the above document creating device, the new paragraph creating unit may be configured not to create the new paragraph when the right cursor key is pressed in the state where no character is inputted in a target paragraph where the cursor is placed.

With this configuration, when a user who is unfamiliar with the operation continuously presses the right cursor key, unnecessary and continuous creation of new paragraphs against the user's intention can be prevented.

In the above document creating device, the new paragraph creating unit may create a new paragraph as the right cursor key is pressed when there is no next paragraph that follows a target paragraph where the cursor is placed.

The above document creating device may further include an inter-paragraph shifting unit which, when there is a next paragraph following the target paragraph, shifts the cursor to the next paragraph when the right cursor key is pressed in the state where the cursor is placed on a final character in a final line of the target paragraph.

With these configurations, creation of a new paragraph and a shift to the next paragraph can be carried out by similar operations. Also, both operations are intuitive and easy to understand.

In the above document creating device, when there is a previous paragraph preceding the target paragraph and when a left cursor key is pressed in the state where the cursor is placed at a leading end position in the target paragraph, the inter-paragraph shifting unit may shift the cursor to the previous paragraph.

With this configuration, opposite actions, that is, a shift to the next paragraph and a shift to the previous paragraph, are realized by pressing the right cursor key and the left cursor key, respectively. Therefore, the operations are easy to understand.

The above document creating device may further include an editing screen display unit which displays a character string corresponding to each line of the paragraph, arrayed in a vertical line with a beginning of each line aligned. The editing screen display unit may display each paragraph arrayed in a left-right direction so that a line number of each paragraph and a displayed line on an editing screen coincide with each other.

In the above document creating device, as the new paragraph creating unit creates a new paragraph, the editing screen display unit may display the cursor indicating an input start position of the new paragraph on the right-hand side of a character string display area of a paragraph before shift where the cursor is previously placed.

With these configurations, each paragraph is displayed, arrayed in the left-right direction so that the line number of each paragraph and the displayed line on the editing screen coincide with each other. Therefore, the position where the paragraph is created and the editing position are linked with each other. Also, as the new paragraph is created, the cursor indicating the input start position of the new paragraph is displayed on the right-hand side of the character string display area of the paragraph before shift. Therefore, even a user who is unfamiliar with the operation can create a new paragraph by an intuitive operation.

The above document creating unit may further include a print preview screen display unit which displays a print preview screen. As the new paragraph creating unit creates a new paragraph, the print preview screen display unit may display a new paragraph image showing a creation position of the new paragraph on the right-hand side of a preview display area of a paragraph before shift where the cursor is previously placed.

With this configuration, since a new paragraph image showing the creation position of the new paragraph is displayed on the print preview screen, the user can grasp which position the paragraph to be created from now is arranged at, before inputting characters.

Still another aspect of the invention is directed to a tape printing apparatus including each unit of the above document creating device and a printing unit which prints, on a tape, a document created by the document creating unit.

With this configuration, a tape printing apparatus which can creates a new paragraph by an intuitive operation and which can create various different labels by arranging plural paragraphs on one tape can be realized.

### BRIEF DESCRIPTION OF THE DRAWINGS

The invention will be described with reference to the accompanying drawings, wherein like reference numbers reference like elements.

FIG. 1 is an external perspective view of a tape printing apparatus according to a first embodiment.

FIG. 2 is a control block diagram of the tape printing apparatus.

FIG. 3 is a screen transition view showing processing procedures related to paragraph editing.

FIG. 4 is a screen transition view continued from FIG. 3.

FIG. 5 is a screen transition view continued from FIG. 4.

FIG. 6A is a screen transition view showing a method for dividing paragraphs. FIGS. 6B and 6C show modifications of screen display.

### DESCRIPTION OF EXEMPLARY EMBODIMENTS

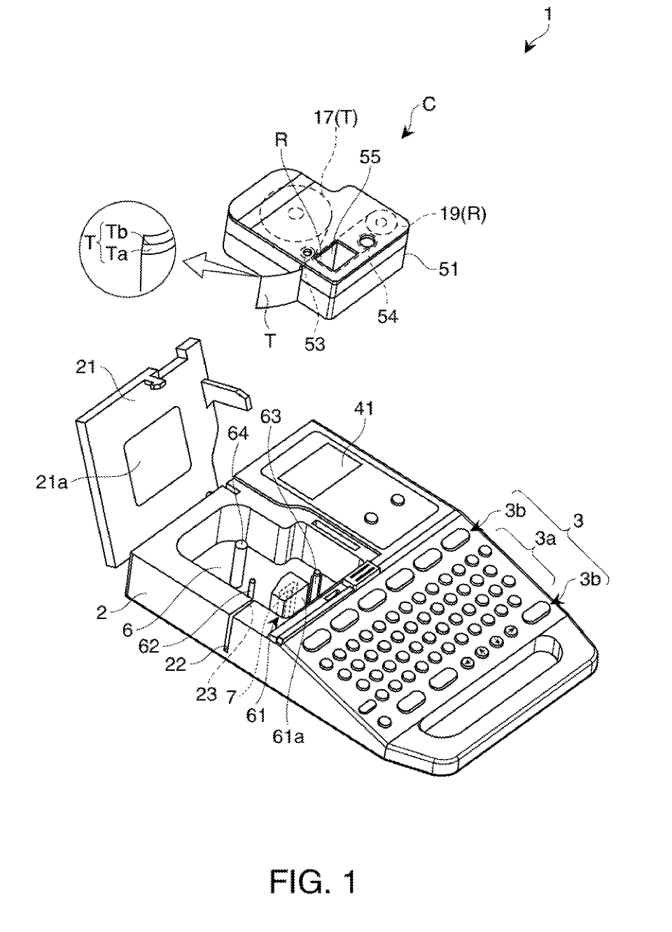

Hereinafter, an embodiment of the invention will be described in detail with reference to the accompanying drawings. In this embodiment, a case where a “document creating device” according to the appended claims is applied to a tape printing apparatus which prints on a tape is described. FIG. 1 is an external perspective view showing the state where an open-close cover 21 of a tape printing apparatus 1 according to this embodiment is opened. As shown in FIG. 1, an apparatus case 2 forms an exterior of the tape printing apparatus 1. A keyboard 3 having various input keys is arranged on a front top surface of the apparatus case 2. On a rear top surface thereof, the open-close cover 21 is attached on the left-hand side and a display screen 41 is arranged on the right-hand side.

Inside the open-close cover 21, a cartridge loading section 6 for loading a tape cartridge C is formed in a recessed manner. The tape cartridge C is removably loaded in the cartridge loading section 6 in the state where the open-close cover 21 is opened. Also, a viewing window 21a through which to visually confirm whether the tape cartridge C is loaded or not loaded in the state where the open-close cover 21 is closed is formed in the open-close cover 21.

On the keyboard 3, a character key group 3a, and a function key group 3b for designating various operation modes and the like are arranged. The character key group 3a has a full-key configuration based on the JIS arrangement and is similar to a general word processor, including a [Shift] key in order to restrain an increase in the number of keys to be operated. The function key group 3b includes a [Print] key, [Cursor] keys, a [Select (Return)] key and the like.

The [Print] key is a key to execute printing. After inputting information with the character key group 3a, the user presses the [Print] key to execute printing based on the input information (created document). The [Cursor] keys include up, down, left and right keys (up cursor key, down cursor key, left cursor key, and right cursor key) and these are keys to move the cursor or to scroll. This embodiment is characterized in that the cursor keys are used to create a new paragraph or to move between paragraphs. Details will be described later. The up, down, left and right keys are hereinafter denoted as [↑] key, [↓] key, [←] key and [→] key. The [Select (Return)] key is a key for selection and line break and is hereinafter denoted as [Return] key.

The display screen 41 is a liquid crystal display and is used to check an editing result based on input information inputted by the user using the keyboard 3, or print data or the like generated based on the editing result.

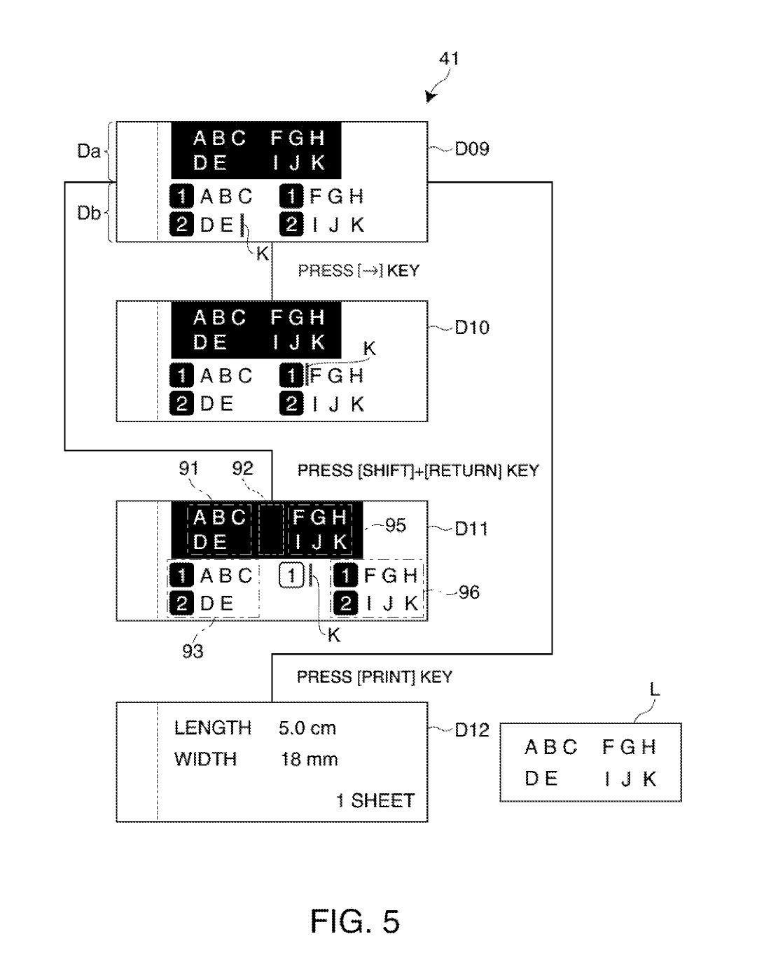

On a left-side portion of the apparatus case 2, a tape discharge port 22 connecting the cartridge loading section 6 to outside is formed. In this tape discharge port 22, a tape cutter 23 for cutting a tape T reeled out by a tape feeding mechanism, not shown, is present. As the tape T that is already printed is reeled out by a predetermined length from the tape discharge port 22 and the reeling out is paused, the printed tape T is cut by the cutter 23, creating a strip-like label L (see FIG. 5).

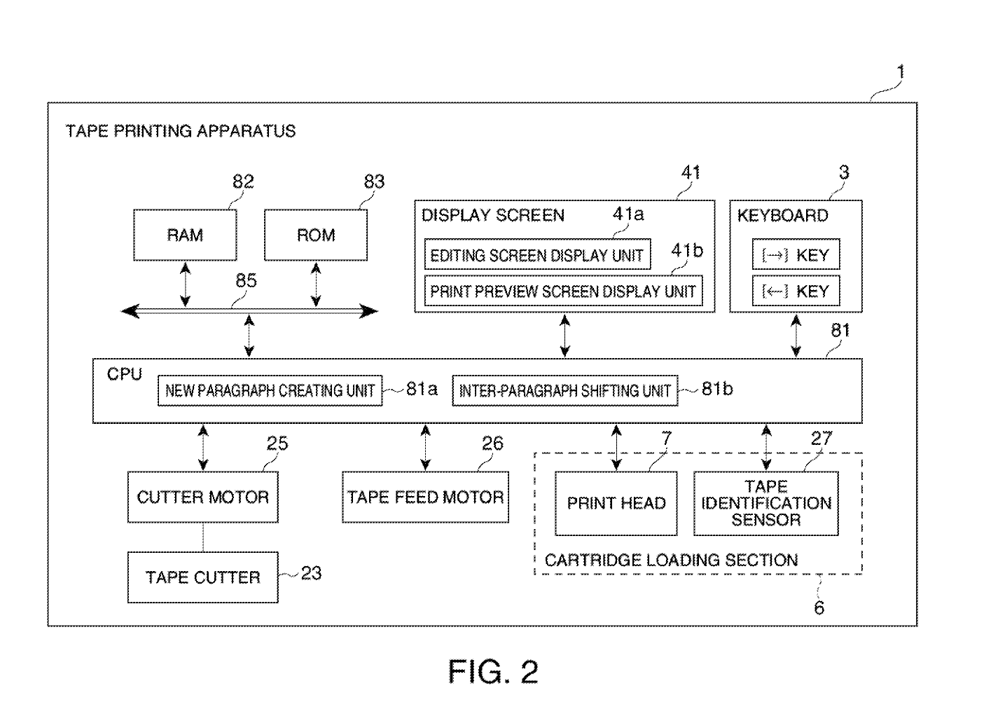

Meanwhile, the cartridge loading section 6 includes a head unit 61 having a thermal-type print head 7 enclosed in a head cover 61a, a platen drive shaft 62 facing the print head 7, a take-up drive shaft 63 which takes out an ink ribbon R, later described, and a positioning protrusion 64 for a tape reel 17, later described. In apart below the cartridge loading section 6, a tape feed motor 26 (see FIG. 2) which rotates the platen drive shaft 62 and the take-up drive shaft 63 as a tape feed mechanism is enclosed.

The tape cartridge C accommodates the tape reel 17 having the tape T with a predetermined width (approximately 4 to 48 mm) wound thereon, at a central part of an upper part inside a cartridge case 51, and a ribbon reel 19 having the ink ribbon R wound thereon, at a right bottom part. The tape T and the ink ribbon R have the same width. Also, a through-hole 55 for the head cover 61a covering the head unit 61 to be inserted therein is formed in a left bottom part of the tape reel 17. Moreover, the head unit 61 inserted in the through-hole 55, and a platen roller 53 which is engaged with the platen drive shaft 62 and rotationally driven, are arranged corresponding to a part where the tape T and the ink ribbon R overlap each other. Meanwhile, a ribbon take-up reel 54 is arranged near the ribbon reel 19. The ink ribbon R reeled out from the ribbon reel 19 is taken up by the ribbon take-up reel 54 in a manner of circling around the head cover 61a. That is, the ink ribbon R is taken up by the ribbon take-up reel 54 via a ribbon traveling path on a circumferential wall of the through-hole 55.

As the tape cartridge C is loaded in the cartridge loading section 6, the head cover 61a is inserted in the through-hole 55, the positioning protrusion 64 is inserted in a center hole of the tape reel 17, and the take-up drive shaft 63 is inserted in a center hole of the ribbon take-up reel 54. The print head 7 abuts on the platen roller 53 with the tape T and the ink ribbon R held between the print head 7 and the platen roller 53, thus enabling print. After that, as the user inputs a desired document (text information such as characters, numbers, symbols or simple graphics) or image using the keyboard 3 while checking the editing result on the display screen 41 and gives an instruction to print, the tape printing apparatus 1 causes the tape feed motor 26 to reel out the tape T from the tape cartridge C and performs a print operation in which heat generating elements of the print head 7 are selectively made to generate heat, thus printing on the tape T. The printed portion of the tape T is sequentially sent outward from the tape discharge port 22. As the print is completed, the tape feed motor 26 feeds the tape T up to a position corresponding to a tape length including a margin and then stops the feeding. After that, a cutter motor 25 (see FIG. 2) drives the tape cutter 23 to cut the tape T in the direction of the width thereof.

Meanwhile, the tape T includes a recording tape Ta with an adhesive layer formed on a rear side, and a separation tape Tb bonded to the recording tape Ta with the adhesive layer. The tape T is wound in a roll shape, with the recording tape Ta facing outside and the separation tape Tb facing inside, and is thus accommodated in the cartridge case 51. As the tape T, plural different types of tapes (with different tape widths, tape ground colors, ground patterns, materials and the like) are prepared. In each cartridge case 51, the tape T of one of these types (and the ink ribbon R) is accommodated. On a back side of the cartridge case 51, plural holes (not shown) specifying the type of the tape cartridge C are provided. Also, corresponding to the plural holes, plural tape identification sensors (micro switches or the like) 27 (see FIG. 2) which detect these holes are provided in the cartridge loading section 6. As the tape identification sensors 27 detect the state of the plural holes, the tape type can be discriminated.

Next, the control configuration of the tape printing apparatus 1 will be described with reference to the control block diagram of FIG. 2. The tape printing apparatus 1 includes a CPU (central processing unit) 81, a RAM (random access memory) 82, a ROM (read only memory) 83, the display screen 41, the keyboard 3, a cutter motor 25, the tape cutter 23, the tape feed motor 26, the print head 7 and the tape identification sensors 27. Of these, the RAM 82 and the ROM 83 are connected to the CPU 81 via a bus 85. The other components are directly connected to the CPU 81.

The CPU 81 is a central processing unit and functions as a new paragraph creating unit 81a and an inter-paragraph shifting unit 81b. A “paragraph” refers to an aggregate of lines (or one line) and is a unit that designates various styles (decoration, and arrangement and configuration). The “paragraph” is different from the concept of “page” in that character insertion and increase in the number of lines within the paragraph do not influence other paragraphs. Styles that can be designated on a “paragraph” basis include “outer frame and table” for designating a decorative frame and table creation, “allocation” for designating the position of allocation of each line such as forward justification, centering, full justification or rear justification, “decorated character” for implementing decoration such as solid-white character, shaded character or shaded solid-white character, “character spacing” for designating the spacing between characters, “enclosure and hatching” for implementing decoration such as correction line, underline, hatching or enclosure, “expansion and contraction” for deforming characters by expansion or contraction, “italic and highlight” for implementing decoration such as italic, highlight or highlighted italic, “vertical and horizontal” for designating vertical writing or horizontal writing, “character size” for designating a character size of each line, “font” for designating the font of Chinese characters, Japanese kana characters and alphanumeric characters, and the like.

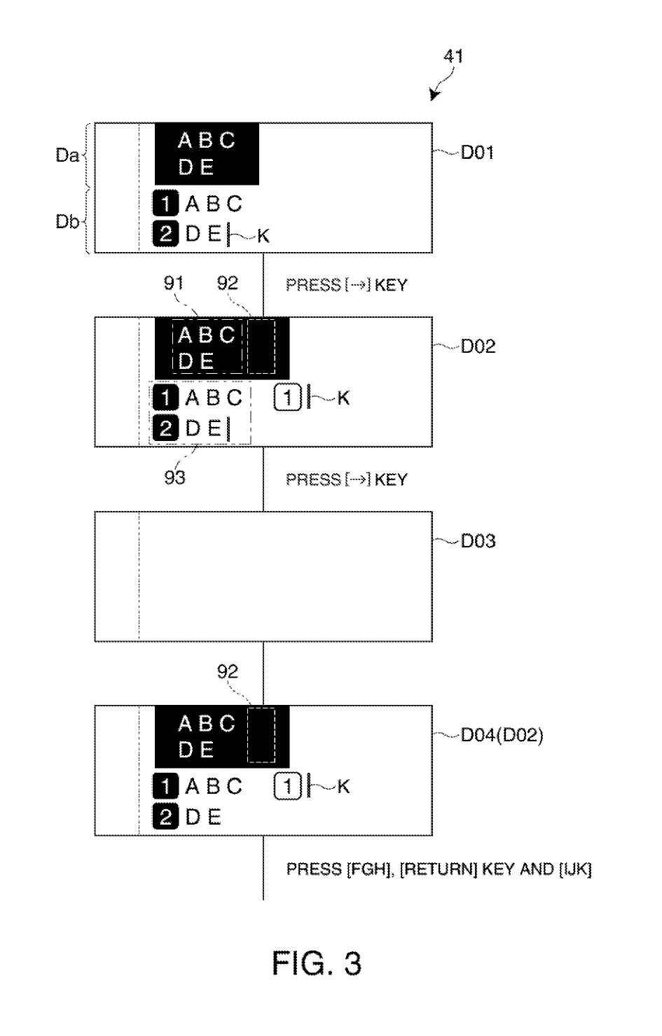

The new paragraph creating unit 81a creates a new paragraph when the [→] key is pressed in the state where a cursor K (see FIG. 3 and the like) is placed on the final character in the final line of the paragraph. However, the creation of a new paragraph is carried out only when there is no next paragraph that follows the target paragraph where the cursor K is placed. As the [→4] key is pressed when there is a next paragraph that follows the target paragraph, a shift to the next paragraph is carried out by the inter-paragraph shifting unit 81b. Also, the creation of a new paragraph is carried out only when a character is inputted in the target paragraph where the cursor K is placed. Thus, when a user who is unfamiliar with the operation continuously presses the [→] key, unnecessary and continuous creation of new paragraphs can be prevented. Also, when there is a previous paragraph that precedes the target paragraph and when the [←] key is pressed in the state where the cursor K is placed at the leading end position in the target paragraph (beginning-of-line mark of the first line), the inter-paragraph shifting unit 81b carries out a shift to the previous paragraph.

The RAM 82 is used as a work area for the CPU 81 to carry out various kinds of control. The ROM 83 stores control programs and control information for the CPU 81 to carry out various kinds of control. As the control programs, a paragraph editing program for editing a paragraph, a display control program for display control of the display screen 41, a print and cutting processing program for performing print processing and cutting processing, and the like are stored (not shown).

The display screen 41 functions as an editing screen display unit 41a and a print preview screen display unit 41b. The editing screen display unit 41a displays an editing screen Db showing input information from the keyboard 3 and an editing result thereof (see screen D01 of FIG. 3). The editing screen display unit 41a also displays a character string corresponding to each line of the paragraph, with the beginning of each line aligned in a vertical line, and displays each paragraph arrayed in a left-right direction so that the line numbers in each paragraph coincides with displayed lines on the editing screen Db. The print preview screen display unit 41b displays a print preview screen Da showing print data based on the editing result on the editing screen Db (see screen D01 of FIG. 3) . Also, as the new paragraph creating unit 81a creates a new paragraph, the print preview screen display unit 41b displays a new paragraph image 92 showing the creation position of the new paragraph on the right-hand side of a preview display area 91 of the paragraph before shift where the cursor K is previously placed (see screen D02 of FIG. 3).

The keyboard 3 functions as an information input unit, an editing unit for performing editing processing, a setting unit for implementing various settings, a print instruction unit which gives a print instruction, and the like. The [→] key functions as a paragraph break operation unit and an inter-paragraph shift operation unit (shift to the right paragraph). The [←] key functions as an inter-paragraph shift operation unit (shift to the left paragraph).

The cutter motor 25 is connected with the tape cutter 23 and functions as a cutting unit. The tape feed motor 26 and the print head 7 function as a print unit which print on the tape T while feeding the tape T. As described above, the print head 7 and the tape identification sensors 27 are provided in the cartridge loading section 6, and the tape identification sensors 27 detect the type of the tape T accommodated in the tape cartridge C. Based on the result of the detection by the tape identification sensors 27 (based on the width, material and the like of the tape), the CPU 81 determines limitations on the number of lines, the number of characters and the character size that can be inputted as input information, and whether cutting is possible or not. Moreover, the CPU 81 carries out display control of the display screen 41 and drive control of the print head 7, the cutter motor 25 and the tape feed motor 26, according to an instruction inputted from the keyboard 3.

Next, various kinds of processing related to paragraph editing will be described with reference to the screen transition views of FIGS. 3 to 6C. In the following example, it is assumed that, for the paragraph, “uniform” for setting each line to the same size is designated in terms of “character size”, “forward justification” is designated in terms of “allocation”, and “horizontal writing” is designated in terms of “vertical and horizontal”. It is also assumed that up to two paragraphs can be created.

First, a screen D01 of FIG. 3 shows a display example where characters [ABC], the [Return] key and characters [DE] are inputted. A screen top part of the display screen 41 is the print preview screen Da, showing an image of the tape T (solid-black area) and print data (solid-white characters). A screen bottom part of the display screen 41 is the editing screen Db, which can display character strings equivalent to two lines, after beginning-of-line marks. A beginning-of-line mark is a solid-white number indicating the line number, enclosed in a solid-black quadrilateral. However, for a line where no characters are inputted, a black number indicating the line number is displayed, enclosed in a solid-white quadrilateral (see screen D02 or the like). Also, the editing screen Db displays the cursor K (a vertical line) indicating the editing position on the right-hand side of the character that is an editing subject. That is, in the screen D01, the cursor K is appended to the character “E”.

As the [→4] is pressed in the state where the cursor

K is appended to the final character in the final line of the first paragraph (where the cursor K is placed at the final position in the first paragraph) as shown in the screen D01, a new paragraph is created, thus shifting to a screen D02. This means that paragraph break is carried out by pressing the [→] key. As paragraph break is carried out, the cursor K indicating an input start position of the new paragraph (second paragraph) is displayed on the right-hand side of a character string display area 93 of the paragraph before shift (first paragraph) where the cursor K is previously placed (rectangular area surrounding the character string group of the first paragraph). At this point, the beginning-of-line mark of the first line of the second paragraph is displayed in the same line as the first line of the first paragraph, and the cursor K is appended to this beginning-of-line mark. Also, a space equivalent to one character is inserted between the character string display area 93 of the first paragraph and the beginning-of-line mark of the second paragraph. Meanwhile, in the print preview screen display unit 41b, as paragraph break is carried out, the new paragraph image 92 indicating the creation position of the new paragraph is displayed on the right-hand side of the preview display area 91 of the first paragraph (rectangular area surrounding the character string group of the first paragraph). The new paragraph image 92 is displayed as a dotted-line frame as shown in FIG. 3 or as a rotary enclosure line where a dotted-line frame rotates. The new paragraph image 92 turns to non-display state when a character is inputted in the new paragraph.

Next, as the [→4] key is pressed in the state of the screen D02, display data turns to non-display state for a moment, as shown in a screen D03. This gives a warning to the user. Hereinafter, this non-display screen is referred to as a “warning screen”. After the warning screen is displayed, the state of the screen D02 is restored (screen D04). In this manner, this embodiment is configured in such a way that a new paragraph is not created when the [→] key is pressed in the state where no characters are inputted in the target paragraph (second paragraph) where the cursor K is placed. Of course, when the cursor K is placed in the first paragraph and the [→] is pressed in the state where no characters are inputted in the first paragraph, a new paragraph is not created, either. In this embodiment, since only up to two paragraphs can be created, the pressing of the [→] key causes the warning screen to be displayed even if characters are inputted in the second paragraph.

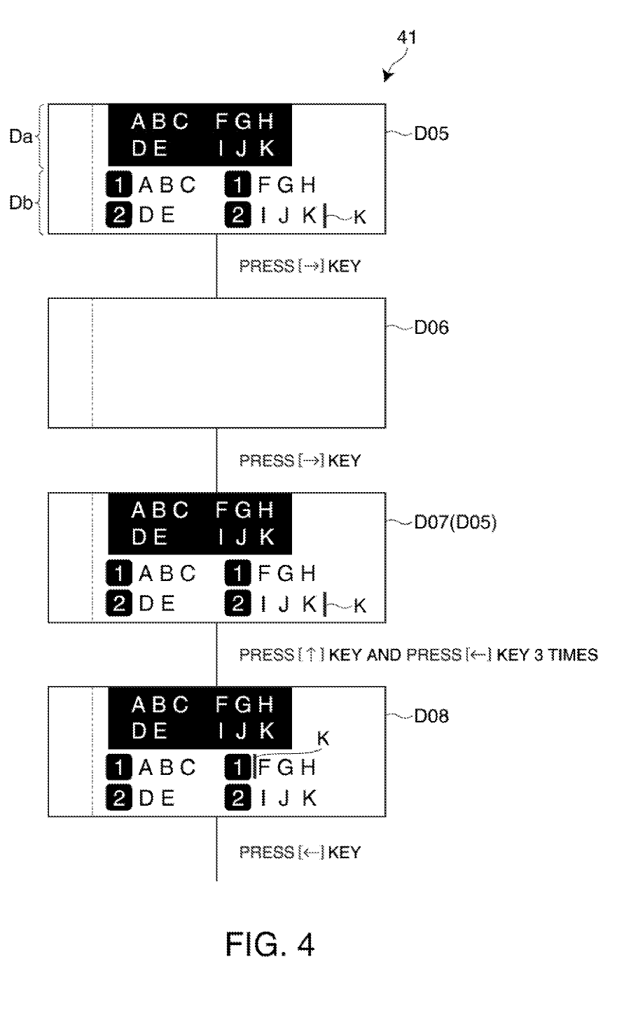

For example, as characters [FGH], the [Return] key and [IJK] are pressed in the state of the screen D04, state shown in a screen D05 of FIG. 4 appears. As the [→] key is pressed in the state where the cursor K is appended to the final character (final position, character “K”) in the final line of the second paragraph as shown in the screen D05, creation of paragraphs cannot exceed two paragraphs and therefore a warning screen (screen D06) is displayed. After the warning screen is displayed for a moment, the screen returns to the previous screen (screen D05 (D07)).

Also, as the [↑] key is pressed once and the [←] key is pressed three times in the state of the screen D07, the cursor K shifts in response to this pressing and the cursor K is appended to the beginning-of-line mark in the first line of the second paragraph, as shown in a screen D08. As the [←] key is pressed in the state where the cursor K is appended to the leading end position in the second paragraph in this manner, the cursor K shifts to the final position in the first paragraph, as shown in a screen D09 of FIG. 5. On the contrary, as the [→] key is pressed in the state where the cursor K is appended to the final position in the first paragraph, the cursor K shifts to the leading end position in the second paragraph, as shown in a screen D10. This is because when there is a next paragraph (second paragraph) following the target paragraph (first paragraph) where the cursor K is placed, the pressing of the [→] key is regarded as an inter-paragraph shift operation instead of a paragraph break operation.

When a new paragraph is to be created between the first paragraph and the second paragraph (though, in this case, it is assumed that three or more paragraphs can be created), a new paragraph can be added (screen D11) by simultaneously pressing the [Shift] key and the [Return] key in the state of the screen D09. In this case, on the print preview screen display unit 41b, the new paragraph image 92 indicating the creation position of the new paragraph is displayed on the right-hand side of the preview display area 91 of the first paragraph and on the left-hand side of a preview display area 95 of the former second paragraph (new third paragraph). Also, on the editing screen Db, the cursor K indicating the input start position of the new paragraph (second paragraph) is displayed on the right-hand side of the character string display area 93 of the first paragraph and on the left-hand side of a character string display area 96 of the former second paragraph (new third paragraph).

Meanwhile, for example, as the [Print] key is pressed in the state of the screen D09, the tape length (length) calculated based on input information, tape width (width) based on the result of detection by the tape identification sensors 27 and the number of sheets to be printed are displayed (screen D12). After printing, the screen returns to D09. The label L created in this case is as shown in FIG. 5 and is substantially similar to the display on the print preview screen Da shown in the screen D09.

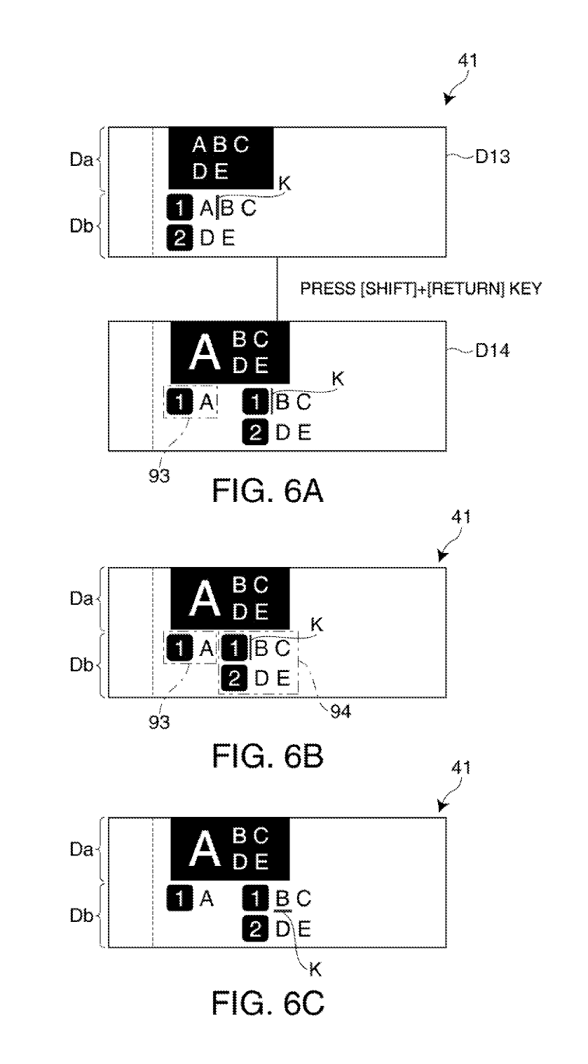

Also, when a paragraph is to be divided, paragraph break can be carried out at a midway part of the paragraph (screen S14) by simultaneously pressing the [Shift] key and the [Return] key in the state where the cursor K is placed at the midway part of the paragraph (excluding the leading end position in the paragraph (beginning-of-line mark in the first line) and the final position in the paragraph) as shown in a screen D13 of FIG. 6A. In this case, the target paragraph (first paragraph) is edited, assuming the character to which the cursor K is appended (character “A”) as the final character, and the next paragraph (second paragraph) is created, assuming the next character (character “B”) following the character to which the cursor K is appended, as a leading character. Also, the cursor K is appended to the right-hand side of the character string display area 93 of the first paragraph and at the leading end position in the second paragraph. In the print preview screen display unit 41b, as the number of lines in the first paragraph is changed from two to one, the size of the character (character “A”) in the first paragraph is enlarged in the display.

The display on the editing screen Db may employ the following modifications. For example, while a space equivalent to one character is inserted between the first paragraph and the second paragraph in the above example (see screen D14 or the like), the space between paragraphs may be omitted as shown in FIG. 6B. That is, the character string display area 93 of the first paragraph and the character string display area 94 of the second paragraph may be arranged closely to each other in the left-right direction. This configuration is convenient because the configuration enables display of as much information as possible when the display screen 41 is small.

Also, while the cursor K is shown as a vertical line in the above example (see screen D14 or the like), the cursor K may be shown as a horizontal line as shown in FIG. 6C. In this case, the cursor K is appended below the character of the editing target. When paragraph break or inter-paragraph shift is carried out, the cursor K is appended to the leading end position (beginning-of-line mark in the first line).

As described above, according to the embodiment, when the [→] key is pressed in the state where the cursor K is placed at the final position in the paragraph, a new paragraph is created. Therefore, the paragraph break operation and the creation position of the new paragraph are linked with each other. Thus, even a beginner can create a new paragraph by an intuitive operation without referring to the user's manual. Also, since the editing screen Db displays each paragraph arrayed in the left-right direction so that the line number of each paragraph and the displayed line on the editing screen Db coincide with each other, the creation position of the paragraph and the editing position are linked with each other. Moreover, since the editing screen Db displays the cursor K indicating the input start position of the new paragraph on the right-hand side of the character string display area of the paragraph before shift as the new paragraph is created (see screen D02 of FIG. 3 or the like), the operation key and the change in the editing position coincide with each other, enabling more intuitive operation.

In the print preview screen Da, the new paragraph image 92 indicating the creation position of the new paragraph is displayed (see screen S02 of FIG. 3 or the like). Therefore, the user can grasp which position the paragraph to be created from now is arranged at, before inputting characters.

A new paragraph is created only when a character is inputted to the target paragraph where the cursor K is placed. Therefore, when a user who is unfamiliar with the operation continuously presses the [→] key, unnecessary and continuous creation of new paragraphs against the user's intention can be prevented.

Moreover, when the [→] key is pressed in the state where the cursor K is placed at the final position in the target paragraph, whether there is a next paragraph following the target paragraph or not is determined. If there is not next paragraph, a new paragraph is created. If there is a next paragraph, the cursor K shifts to the next paragraph. Therefore, creation of a new paragraph and shift to the next paragraph can be carried out by similar operations. Both operations are intuitive and easy to understand.

In the embodiment, when the [→] key is pressed in the state where the cursor K is placed at the final position in the target paragraph and when there is no next paragraph following the target paragraph, a new paragraph is created. However, a new paragraph may be created not only when the [→] key is pressed but also when the [Shift] key and the [Return] key are simultaneously pressed. With this configuration, even a user who is unfamiliar with the traditional-style operation can operate the tape printing apparatus 1 without any trouble.

A shift to the next paragraph can also be made when the [→] key is pressed in the state where the cursor K is placed at the final character in a line that is not the final line of the target paragraph. For example, in the screen D05 of FIG. 4, when the [→] key is pressed in the state where the cursor K is appended to the character “C” in the first paragraph, the cursor K may shift to the beginning-of-line mark in the first line of the second paragraph. Moreover, when the [→] key is pressed in the state where the cursor K is appended to the final character in a line that is not the leading line of the target paragraph (for example, the character “E” in the first paragraph), the cursor K may shift to the beginning-of-line mark in the same line (second line) of the second paragraph.

Also, a new paragraph may be created by the pressing of the [→] key not only when there is no next paragraph following the target paragraph where the cursor K is placed but also when there is a next paragraph. In this case, a shift to the next paragraph is made by another key than the [→] key or by simultaneously pressing the [→] key and another key.

Moreover, while the above embodiment assumes that the print preview screen Da and the editing screen Db are displayed simultaneously on the display screen 41, separate display of these screens can be made possible by screen switching. Also, the arrangement of the print preview screen Da and the editing screen Db is not limited to the above embodiment, and it is also possible to display the print preview screen Da below the editing screen Db or to display the print preview screen Da on the right-hand side of the editing screen Db.

Each component of the tape printing apparatus 1 described in each of the above embodiments can be provided as a program. The program can also be stored in various recording media (CD-ROM, flash memory and the like) and provided in this form. That is, a program for causing a computer to function as each part of the tape printing apparatus 1, and a recording medium in which the program is recorded are included in the scope of the invention. In addition, the document creating method according to the invention (paragraph editing processing) may be applied to other electronic devices than the tape printing apparatus 1, such as personal computer and personal digital assistant. Also, changes and modifications can be suitably made without departing from the scope of the invention.

What is claimed is:

1. A document creating device capable of creating plural paragraphs, each including one or more lines, the paragraphs being arrayed in a left-right direction that is a direction of line, the device comprising:
a new paragraph creating unit for creating a new paragraph when a right cursor key for shifting a character spacing to the right is pressed in the state where a cursor is placed on a final character in a final line of the paragraph.

2. The document creating device according to claim 1, wherein the new paragraph creating unit does not create the new paragraph when the right cursor key is pressed in the state where no character is inputted in a target paragraph where the cursor is placed.

3. The document creating device according to claim 1, wherein the new paragraph creating unit creates a new paragraph as the right cursor key is pressed when there is no next paragraph that follows a target paragraph where the cursor is placed.

4. The document creating device according to claim 3, further comprising an inter-paragraph shifting unit for, when there is a next paragraph following the target paragraph, shifting the cursor to the next paragraph when the right cursor key is pressed in the state where the cursor is placed on a final character in a final line of the target paragraph.

5. The document creating device according to claim 4, wherein when there is a previous paragraph preceding the target paragraph and when a left cursor key is pressed in the state where the cursor is placed at a leading end position in the target paragraph, the inter-paragraph shifting unit shifts the cursor to the previous paragraph.

6. The document creating device according to claim 1, further comprising an editing screen display unit for displaying a character string corresponding to each line of the paragraph, arrayed in a vertical line with a beginning of each line aligned,
wherein the editing screen display unit displays each paragraph arrayed in a left-right direction so that a line number of each paragraph and a displayed line on an editing screen coincide with each other.

7. The document creating device according to claim 6, wherein as the new paragraph creating unit creates a new paragraph, the editing screen display unit displays the cursor indicating an input start position of the new paragraph on the right-hand side of a character string display area of a paragraph where the cursor is previously placed.

8. The document creating unit according to claim 1, further comprising a print preview screen display unit for displaying a print preview screen,
wherein as the new paragraph creating unit creates a new paragraph, the print preview screen display unit displays a new paragraph image showing a creation position of the new paragraph on the right-hand side of a preview display area of a paragraph where the cursor is previously placed.

9. A tape printing apparatus comprising:
each unit of the document creating device according to claim 1; and
a printing unit for printing, on a tape, a document created by the document creating unit.

10. A document creating method of a document creating device capable of creating plural paragraphs, each including one or more lines, the paragraphs being arrayed in a left-right direction that is a direction of line, the method comprising:
creating a new paragraph when a right cursor key for shifting a character spacing to the right is pressed in the state where a cursor is placed on a final character in a final line of a paragraph.

11. The document creating method according to claim 10, wherein the new paragraph is not created when the right cursor key is pressed in the state where no character is inputted in a target paragraph where the cursor is placed.

12. The document creating method according to claim 10, wherein a new paragraph is created as the right cursor key is pressed when there is no next paragraph that follows a target paragraph where the cursor is placed.

13. The document creating method according to claim 12, further comprising
shifting the cursor to a next paragraph when the right cursor key is pressed in the state where the cursor is placed on a final character in a final line of the target paragraph in case that there is the next paragraph following the target paragraph.

14. The document creating method according to claim 13, wherein when there is a previous paragraph preceding the target paragraph and when a left cursor key is pressed in the state where the cursor is placed at a leading end position in the target paragraph, the cursor is shifted to the previous paragraph.

15. The document creating method according to claim 10, further comprising
displaying a character string corresponding to each line of the paragraph, arrayed in a vertical line with a beginning of each line aligned,
wherein each paragraph is displayed arrayed in a left-right direction so that a line number of each paragraph and a displayed line on an editing screen coincide with each other.

16. The document creating method according to claim 15, wherein as a new paragraph is created, the cursor indicating an input start position of the new paragraph is displayed on the right-hand side of a character string display area of a paragraph where the cursor is previously placed.

17. The document creating method according to claim 10, further comprising
displaying a print preview screen,
wherein as a new paragraph is created, a new paragraph image showing a creation position of the new paragraph is displayed on the right-hand side of a preview display area of a paragraph where the cursor is previously placed.
